(19) United States
(12) Patent Application Publication
(10) Pub. No.: US 2015/0209826 A1
(43) Pub. Date: Jul. 30, 2015

(54) SILICON OXYNITRIDE MATERIALS HAVING PARTICULAR SURFACE ENERGIES AND ARTICLES INCLUDING THE SAME, AND METHODS FOR MAKING AND USING THEM

(71) Applicant: University of Washington, Seattle, WA (US)

(72) Inventors: Rajendra Bordia, Clemson, SC (US); Brian D. Flinn, Seattle, WA (US); Kaishi Wang, Seattle, WA (US)

(21) Appl. No.: 14/609,262

(22) Filed: Jan. 29, 2015

Related U.S. Application Data
(60) Provisional application No. 61/933,140, filed on Jan. 29, 2014.

(51) Int. Cl. B05D 3/06; B05D 1/38; B05D 1/18; B05D 3/02

(52) U.S. Cl. CPC B05D 3/067; B05D 3/0254; B05D 1/38; B05D 1/18

(57) ABSTRACT

The present disclosure relates to silicon oxynitride materials having a variety of surface energies. One aspect of the disclosure is a method for forming a ceramic/substrate interface comprising forming a layer of substantially perhydrogenated polysilazane on a surface of a substrate; exposing the layer of substantially perhydrogenated polysilazane to energy sufficient to form a silicon oxynitride layer having an exposed surface, the exposed surface of the silicon oxynitride layer having a surface energy of at least about 50 mN/m; disposing a ceramic material or a precursor thereof on the silicon oxynitride layer; and heat treating to form the ceramic/substrate interface. Another aspect of the disclosure is an article having a patterned silicon oxynitride surface comprising a first region; and a second region, the second region having a surface energy substantially lower than the surface energy of the first region.

### CROSS-REFERENCE TO RELATED APPLICATIONS

This application claims the benefit of priority of U.S. Provisional Patent Application No. 61/933,140, filed Jan. 29, 2014, which is hereby incorporated herein by reference in its entirety.

### STATEMENT OF GOVERNMENT SUPPORT

This invention was made with government support under contract no. FA95550-09-1-0633 awarded by the United States Air Force Office of Scientific Research. The government has certain rights in the invention.

### BACKGROUND OF THE DISCLOSURE

1. Field of the Disclosure

The present disclosure relates generally to ceramic materials and methods for making and using them. More particularly, the present disclosure relates to silicon oxynitride materials having a variety of surface energies, articles comprising such materials, and methods for making and using them.

2. Technical Background

Ceramic films are widely used in the components of electronic devices, solar cells, light-emitting diodes, and wear-resistant parts. SiOₓ, as an example, is a good dielectric material that can be further modified into low-K dielectrics, for use with Cu wiring, to replace the conventional Al/SiO₂ technology in microelectronics industry. SiOₓ can also be used as an environmental barrier or a protective coating in various applications due to its impermeability to gas species, such as moisture, O₂, N₂, Ar, Kr and Xe. Desired properties for such coatings include low weight, low atomic diffusion or permeability, and sometimes, high transparency. Moreover, in certain applications, e.g., self-cleaning coatings and multilayer-structured MEMS, a certain level of hydrophobicity or hydrophilicity is desirable to maximize functionality.

The wetting property of solid surfaces is mainly governed by microstructure and chemical composition. Recent research in the field has mostly focused on patterned surfaces and composite materials with one phase that carries the hydrophobic/hydrophilic property. Typical methods of making such films are self-assembled monolayer (SAM), lithography/imprinting techniques, plasma-enhanced chemical vapor deposition (PECVD), physical vapor deposition (PVD), reactive sputtering and sol-gel processing. The vapor phase and sputtering processes have a variety of limitations, including high capital cost, environmental concerns, potentially high defect density and the need for line-of-sight geometries. And sol-gel derived coatings suffer from the high shrinkage associated with the ceramic conversion or low temperature tolerance.

Accordingly, there remains a need for ceramic materials having selectable levels of hydrophobicity/hydrophilicity, and for improved methods for making such materials.

### SUMMARY OF THE DISCLOSURE

In one aspect, the present disclosure provides a method for forming a ceramic/substrate interface comprising a ceramic material disposed on a substrate. The method includes:
forming a layer of substantially perhydrogenated polysilazane on a surface of a substrate;
exposing the layer of substantially perhydrogenated polysilazane to energy sufficient to form a silicon oxynitride layer having an exposed surface, the exposed surface of the silicon oxynitride layer having a surface energy of at least about 50 mN/m;
disposing a ceramic material or a precursor thereof on the exposed surface of the silicon oxynitride layer; and
exposing the layer of the ceramic material or the precursor thereof to sufficient energy to form the ceramic/substrate interface.

In another aspect, the disclosure provides a method for forming a ceramic/substrate interface comprising a ceramic material disposed on a substrate. The method includes:
forming a layer of substantially perhydrogenated polysilazane on a surface of a substrate;
heat treating the layer of substantially perhydrogenated polysilazane at a temperature in the range of about 325° C. to about 750° C. to form a silicon oxynitride layer having an exposed surface;
disposing a ceramic material or a precursor thereof on the exposed surface of the silicon oxynitride layer; and
heat treating the ceramic material or the precursor thereof to form the ceramic/substrate interface.

In another aspect, the disclosure provides an article having a patterned surface. The article includes at least
a first region having a first silicon oxynitride material at the patterned surface, the first silicon oxynitride material having a surface energy; and
a second region having a second silicon oxynitride material at the patterned surface, the second silicon oxynitride material having a surface energy substantially lower than the surface energy of the first silicon oxynitride material.

In another aspect, the disclosure provides a method for making an article having a patterned surface as described above. The method includes
disposing a substantially perhydrogenated polysilazane on a surface of the article;
in the first region, exposing the substantially perhydrogenated polysilazane to energy sufficient to form the first silicon oxynitride film; and
in the second region, exposing the substantially perhydrogenated polysilazane to energy sufficient to form the second silicon oxynitride film, the second region being exposed to substantially less energy than the first region.

A method for forming an article having a silicon oxynitride material at the surface thereof, the silicon oxynitride material having a surface energy of no more than 30 mN/m. The method includes:
forming a layer of substantially perhydrogenated polysilazane on the article;
exposing the layer of substantially perhydrogenated polysilazane to energy sufficient to form a silicon oxynitride layer having an exposed surface having a surface energy no more than about 30 mN/m; and
refraining from exposing the silicon oxynitride layer having the exposed surface having the surface energy no more than about 30 mN/m to energy sufficient to increase the surface energy of the exposed surface to a value above about 30 mN/m.

Another aspect of the disclosure is an article having a silicon oxynitride material at the surface thereof, the silicon oxynitride material having a surface energy of no more than 30 mN/m.

Additional aspects and embodiments will be evident to the person of ordinary skill in the art in view of the present disclosure.

### BRIEF DESCRIPTION OF THE DRAWINGS

FIG. 1 is a schematic cross-sectional flowchart view of a method according to one embodiment of the disclosure;

FIG. 2 is a schematic cross-sectional flowchart view of a method according to another embodiment of the disclosure;

FIG. 3 is a schematic perspective view of an article according to one embodiment of the disclosure;

FIG. 4 is a schematic cross-sectional flowchart view of a method according to another embodiment of the disclosure;

FIG. 5 is a Kaelble plot of a film synthesized at room temperature;

FIG. 6 is a plot of the surface energies of silicon oxynitride films heat treated at other temperatures;

FIG. 7 is a set of FTIR spectra of films heat treated at various temperatures;

FIG. 8 is a set of Raman spectra of films heat treated at various temperatures;

FIG. 9 is a schematic cross-sectional view of a heat treated silicon oxynitride film;

FIG. 10 is a micrograph of the top surface of a silicon oxynitride film made as described herein;

FIG. 11 is a schematic cross-sectional view of an example of a multilayer coating system;

FIG. 12 is a set of top-view photographs of ZrSi₂-filled SiOC composite coatings (heat treated at 800° C. in air) on SiON bond coat layers (with Inconel 617 substrates); and

FIGS. 13-16 are cross-sectional SEM images (backscattered) of two polymer-derived EBC systems, comparing a double-layer coating system (top coat/bond coat) with the single-layer (top coat only) counterpart before and after 200 hours of oxidation exposure.

### DETAILED DESCRIPTION

Before the disclosed processes and materials are described, it is to be understood that the aspects described herein are not limited to specific embodiments, apparati, or configurations, and as such can, of course, vary. It is also to be understood that the terminology used herein is for the purpose of describing particular aspects only and, unless specifically defined herein, is not intended to be limiting.

Throughout this specification, unless the context requires otherwise, the word “comprise” and “include” and variations (e.g., “comprises,” “comprising,” “includes,” “including”) will be understood to imply the inclusion of a stated component, feature, element, or step or group of components, features, elements or steps but not the exclusion of any other integer or step or group of integers or steps.

As used in the specification and the appended claims, the singular forms “a,” “an” and “the” include plural referents unless the context clearly dictates otherwise.

Ranges can be expressed herein as from “about” one particular value, and/or to “about” another particular value. When such a range is expressed, another aspect includes from the one particular value and/or to the other particular value. Similarly, when values are expressed as approximations, by use of the antecedent “about,” it will be understood that the particular value forms another aspect. It will be further understood that the endpoints of each of the ranges are significant both in relation to the other endpoint, and independently of the other endpoint.

Polymeric precursors such as polysiloxanes and polysilazanes can be converted to ceramics in various forms, including foams, fibers, and tapes. When using them to form coatings, shrinkage during pyrolysis can be a concern as it can lead to cracking if the coating thickness exceeds a critical thickness. However, the shrinkage of polymer-derived coatings made from high-yield preceramic polymers such as polysiloxanes and polysilazanes is significantly lower than that for sol-gel derived coatings. The shrinkage can be further reduced by adding inert and reactive particles. Such approaches have demonstrated the ability to make crack free coatings of practical thicknesses.

Perhydropolysilazane (PHPS) is a versatile polymer. It is a precursor to both SiO₂ and Si₃N₄, depending on annealing atmosphere and conditions. To make the process suitable for roll-to-roll mass production, research has been conducted on converting PHPS into amorphous ceramics at or near room temperatures by exposing the as-deposited film to either reactive environments, like ammonia gas or hydrogen peroxide solution; or ultraviolet (UV) light sources, resulting in predominantly SiOₓ in oxygen and predominantly SiNₓ in nitrogen. Often the materials formed by such methods can be a mixed oxide/nitride of silicon, as some nitrogen will often remain from the silazane polymer, and some oxygen is often present in the film even when reacted in an inert environment. Additionally, heat treatment of PHPS has also been extensively investigated, revealing that the polymer can be fully converted to an inorganic at intermediate with a high ceramic yield. Here, too, silicon oxynitrides are often formed, with the relative amount of oxygen and nitrogen in the film being controllable by the reaction conditions. Examples of heat treatment of PHPS are described, for example, in Bauer, F.; Decker, U.; Dierdorf, A.; Ernst, H.; Heller, R.; Liebe, H.; Mehnert, R., Preparation of moisture curable polysilazane coatings Part I. Elucidation of low temperature curing kinetics by FT-IR spectroscopy. Prog. Org. Coat. 2005, 53, (3), 183-190; Günthner, M.; Wang, K.; Bordia, R. K.; Motz, G., Conversion behaviour and resulting mechanical properties of polysilazane-based coatings. J. Eur. Ceram. Soc. 2012, 32, (9), 1883-1892; AND Schwab, S. T.; Graef, R. C.; Blanchard, C. R.; Dec, S. F.; Maciel, G. G., The pyrolytic conversion of perhydropolysilazane into silicon nitride. Ceram. Int. 1998, 24, (6), 411-414, each of which is hereby incorporated by reference herein in its entirety for all purposes.

The inventors have surprisingly discovered that silicon oxynitride materials can be provided with radically different surface energies depending on the extent of conversion and oxidation of a substantially perhydrogenated polysilazane to silicon oxynitride. The inventors have determined that the extent of conversion of oxidation of polysilazane can be controlled using process parameters such as the amount of energy used in the processing of the polysilazane, Critically, the inventors have discovered that the silicon oxynitride formed by exposing to energy (e.g., heat energy) a substantially perhydrogenated polysilazane experiences an abrupt surface energy transition from low surface energy to high surface energy (e.g., from hydrophobic to hydrophilic) within a relatively narrow window of applied energy. For example, the relatively narrow window can be a relatively small temperature window when the energy is supplied by heat treatment for a particular amount of time, or a relatively small time window when the energy is supplied by heat treatment at a particular temperature. In other embodiments, the relatively small window can be a relatively small intensity window when the energy is supplied by radiation (e.g., UV radiation) for a particular amount of time, or a relatively small time window when the energy is supplied by radiation (e.g., UV radiation) at a particular intensity. This surprising property allows the person of ordinary skill in the art to form a number of new articles and to practice a number of new methods as described herein.

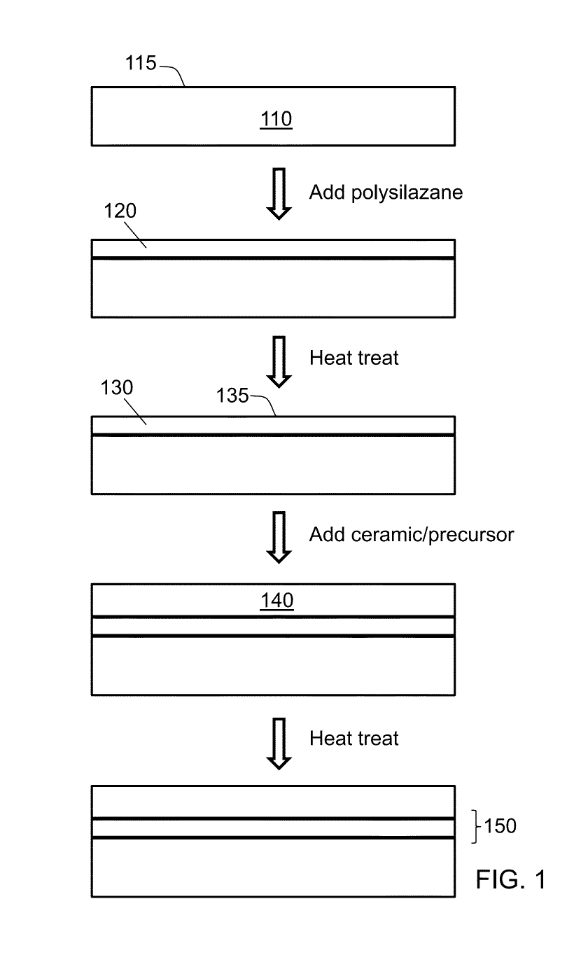

One aspect of the disclosure is a method for forming a ceramic/substrate including a ceramic material disposed on a substrate. One embodiment of such a method is shown in cross-sectional schematic cross-sectional flowchart view in FIG. 1. First, a layer 120 of substantially perhydrogenated polysilazane is formed on a surface 115 of a substrate 110. The layer of substantially perhydrogenated polysilazane is heat treated at a temperature in the range of about 325° C. to about 750° C. to form a silicon oxynitride layer 130 having an exposed surface 135. Then, a ceramic material or a precursor thereof 140 is disposed on the exposed surface of the silicon oxynitride layer. The ceramic material or precursor thereof is heat treated to form the ceramic/substrate interface 150. If a precursor is used, the heat treatment is also sufficient to substantially convert the precursor to a corresponding ceramic. As described in more detail in the Experimental description, Data and Analysis section below, the heat treatment of substantially perhydrogenated polysilazane materials at temperatures in the range of about 325° C. to about 750° C. results in silicon oxynitride films having high surface energy. The surface energies of such films can be even higher than the surface energy of similar films heat treated at temperatures of about 800° C. The high surface energy of such films can advantageously provide increased wetting and bonding of an overlying ceramic material.

In view of the disclosure provided herein, the person of ordinary skill in the art can perform the heat treatment at a variety of temperatures and for a variety of times in order to form a silicon oxynitride having a desirably high surface energy and thus a desirably high level of hydrophilicity. For example, in certain embodiments, the layer of substantially perhydrogenated polysilazane is heat treated at a temperature in the range of about 325° C. to about 700° C. In other embodiments, the layer of substantially perhydrogenated polysilazane is heat treated at a temperature in the range of about 400° C. to about 600° C. For example, in certain embodiments, the layer of substantially perhydrogenated polysilazane is heat treated at a temperature in the range of about 325° C. to about 650° C., about 325° C. to about 550° C., about 350° C. to about 750° C., about 350° C. to about 700° C., about 350° C. to about 650° C., about 350° C. to about 600° C., about 350° C. to about 550° C., about 400° C. to about 750° C., about 400° C. to about 700° C., about 400° C. to about 650° C., about 400° C. to about 600° C., about 400° C. to about 550° C., about 500° C. to about 750° C., about 500° C. to about 700° C., or about 500° C. to about 650° C. The heat treatment can be performed (i.e., at a temperature described above), for example, for a time within the range of about 1 minute to about 10 hours. In certain embodiments, the heat treatment is performed for a time in the range of about 1 minute to about 7 hours, about 1 minute to about 6 hours, about 1 minute to about 5 hours, about 1 minute to about 4 hours, about 1 minute to about 3 hours, about 1 minute to about 2 hours, about 5 minutes to about 7 hours, about 5 minutes to about 6 hours, about 5 minutes to about 5 hours, about 5 minutes to about 4 hours, about 5 minutes to about 3 hours, about 5 minutes to about 2 hours, about 15 minutes to about 7 hours, about 15 minutes to about 6 hours, about 15 minutes to about 5 hours, about 15 minutes to about 4 hours, about 15 minutes to about 3 hours, about 15 minutes to about 2 hours, about 30 minutes to about 7 hours, about 30 minutes to about 6 hours, about 30 minutes to about 5 hours, about 30 minutes to about 4 hours, about 30 minutes to about 3 hours, about 30 minutes to about 2 hours, about 30 minutes to about 7 hours, about 1 hour to about 6 hours, about 1 hour to about 5 hours, about 1 hour to about 4 hours, about 1 hour to about 3 hours, or about 1 hour to about 2 hours.

As described above, the heat treatment can be performed to provide a silicon oxynitride film with a desirably high surface energy. For example, in certain embodiments, the heat treatment is performed to provide the exposed surface of the silicon oxynitride film with a surface energy of at least about 50 mN/m. In other embodiments, the heat treatment is performed to provide the exposed surface of the silicon oxynitride film with a surface energy of at least about 52 mN/m, at least about 55 mN/m, or at least about 57 mN/m. In certain embodiments, the heat treatment is performed to provide the exposed surface of the silicon oxynitride film with a surface energy in the range of about 50 mN/m to about 80 mN/m, or about 52 mN/m to about 80 mN/m, or about 55 mN/m to about 80 mN/m, or about 57 mN/m to about 80 mN/m, or about 50 mN/m to about 75 mN/m, or about 52 mN/m to about 75 mN/m, or about 55 mN/m to about 75 mN/m, or about 57 mN/m to about 75 mN/m, or about 50 mN/m to about 70 mN/m, or about 52 mN/m to about 70 mN/m, or about 55 mN/m to about 70 mN/m, or about 57 mN/m to about 70 mN/m, or about 50 mN/m to about 65 mN/m, or about 52 mN/m to about 65 mN/m, or about 55 mN/m to about 65 mN/m, or about 57 mN/m to about 65 mN/m, or about 50 mN/m to about 60 mN/m, or about 52 mN/m to about 60 mN/m, or about 55 mN/m to about 60 mN/m, or about 57 mN/m to about 60 mN/m.

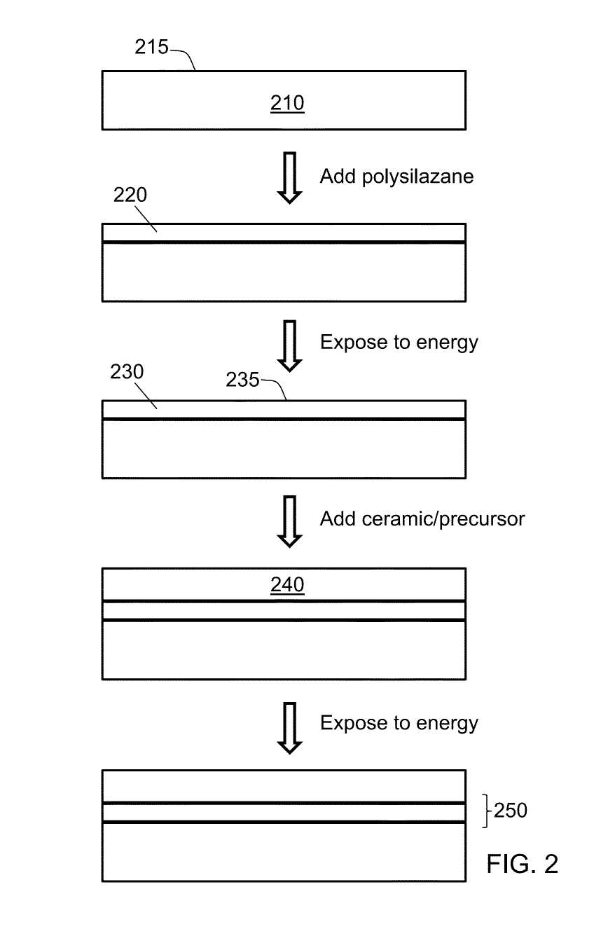

As described in more detail below, high surface energy silicon oxynitride films can advantageously provide increased wetting and bonding of an overlying ceramic material. Accordingly, another aspect of the disclosure relates to the use of high surface energy silicon oxynitride films to make a ceramic/substrate interface. One embodiment of such a method is shown in cross-sectional schematic flowchart view in FIG. 2. First, a layer 220 of substantially perhydrogenated polysilazane is formed on a surface 215 of a substrate 210. The layer of substantially perhydrogenated polysilazane is exposed to energy sufficient to form a silicon oxynitride layer 130 having an exposed surface 135 having a surface energy of at least about 50 mN/m. Then, a ceramic material or a precursor thereof 140 is disposed on the exposed surface of the silicon oxynitride layer. The ceramic material or precursor thereof is exposed to energy sufficient to form the ceramic/substrate interface 150. If a precursor is used, the energy is also sufficient to substantially convert the precursor to a corresponding ceramic. As described in more detail in the Experimental description, Data and Analysis section below, the use of high surface energy of such films can advantageously provide increased wetting and bonding of an overlying ceramic material.

In certain embodiments, the exposure of the layer of the substantially perhydrogenated polysilazane to energy is performed to provide the exposed surface of the silicon oxynitride film with a surface energy of at least about 52 mN/m, at least about 55 mN/m, or at least about 57 mN/m. In certain embodiments, the exposure to energy is performed to provide the exposed surface of the silicon oxynitride film with a surface energy in the range of about 50 mN/m to about 80 mN/m, or about 52 mN/m to about 80 mN/m, or about 55 mN/m to about 80 mN/m, or about 57 mN/m to about 80 mN/m, or about 50 mN/m to about 75 mN/m, or about 52 mN/m to about 75 mN/m, or about 55 mN/m to about 75 mN/m, or about 57 mN/m to about 75 mN/m, or about 50 mN/m to about 70 mN/m, or about 52 mN/m to about 70 mN/m, or about 55 mN/m to about 70 mN/m, or about 57 mN/m to about 70 mN/m, or about 50 mN/m to about 65 mN/m, or about 52 mN/m to about 65 mN/m, or about 55 mN/m to about 65 mN/m, or about 57 mN/m to about 65 mN/m, or about 50 mN/m to about 60 mN/m, or about 52 mN/m to about 60 mN/m, or about 55 mN/m to about 60 mN/m, or about 57 mN/m to about 60 mN/m.

The energy used to form the high surface energy silicon oxynitride layer can take a variety of forms. For example, in certain embodiments, the energy used to form the high surface energy silicon oxynitride layer is heat energy. The heat energy can be, for example, provided by heat treatment using any of the temperature and/or time ranges described above with respect to heat treatment of substantially perhydrogenated polysilazane. Of course, in view of the disclosure provided herein, the person of ordinary skill in the art can determine other suitable heat treatment regimens to provide a silicon oxynitride layer having a desired surface energy; e.g., hotter temperatures for shorter amounts of time; or cooler temperatures for longer amounts of time. In other embodiments, the energy used to form the high surface energy silicon oxynitride layer is radiation (e.g., ultraviolet radiation such as VUV radiation), provided, for example, by irradiation with a laser or with a lamp, or electron beam radiation. The person of ordinary skill in the art will appreciate that exposure with radiation will exhibit behavior similar to that described above and detailed below with respect to FIG. 6, i.e., an abrupt surface energy transition with applied radiation.

The methods described above use a substantially perhydrogenated polysilazane. In certain embodiments, the substantially perhydrogenated polysilazane is perhydropolysilazane, having the idealized formula H(SiH₂NH)ₙH. As the person of ordinary skill in the art will appreciate, the perhydropolysilazane can be provided in a partially-crosslinked and/or cyclized state, meaning the true chemical formula of the perhydropolysilazane can differ somewhat from the idealized formula. Moreover, in certain embodiments, the substantially perhydrogenated polysilazane is not completely substituted with hydrogen, but rather includes a relatively small amount (e.g., less than 10%, less than 5%, less than 2%, less than 1%, less than 0.5%) of organic substitutions in place of the hydrogen substituents of perhydropolysilazane. The use of the term “perhydrogenated” herein is meant to describe only the chemical substitution of the polysilazane; perhydrogenated materials need not be synthesized using a hydrogenation process.

In the methods described above, the layer of substantially perhydrogenated polysilazane can be provided with a variety of thicknesses. For example, in certain embodiments, the layer of substantially perhydrogenated polysilazane is in the range of about 10 nm to about 10 μm (e.g., about 100 nm to about 5 μm) in thickness. In certain embodiments, relatively thicker coatings of silicon oxynitride of a desired surface energy can be built up by forming multiple layers (e.g., depositing a substantially perhydrogenated polysilazane, exposing to energy to provide a desired surface energy, then repeating the deposition/exposure steps to build up to a desired thickness).

The person of ordinary skill in the art will appreciate that the heat treatment of the substantially perhydrogenated polysilazane layer or the exposure of the substantially perhydrogenated polysilazane layer to energy can be performed in a variety of fashions. For example, in certain embodiments, the heat treatment of the substantially perhydrogenated polysilazane layer or the exposure of the substantially perhydrogenated polysilazane layer to energy is performed in an oxygen-containing atmosphere, e.g., air. The person of ordinary skill in the art can adjust exposure conditions (e.g., time, temperature, type of energy source, atmosphere) to provide materials having a desired surface energy based on the disclosure herein.

The methods described above can be used in conjunction with a number of different types of substrates. For example, in certain embodiments, the substrate is a metal substrate, optionally with a surface layer of metal oxide. The optional metal oxide layer can be grown in a separate step via thermal oxidative techniques, or can be a thin layer of metal oxide resulting from atmospheric oxidation, as the person of ordinary skill in the art would appreciate. Of course, in other embodiments, the substrate is a semiconductor material (e.g., silicon), optionally with a semiconductor oxide surface layer or a glass material (e.g., a silica glass). In certain embodiments, the substrate can be a polymeric material, e.g., a polymer matrix composite.

Similarly, the methods described above can be used in conjunction with a variety of different ceramic materials. The ceramic material can be, for example, amorphous, partially crystalline or substantially crystalline, and can be homogeneous or inhomogeneous. Moreover, the ceramic material can be filled, for example, with particles of one or more different materials. In one particular embodiment, the ceramic material is a silicon oxycarbide material. The silicon oxycarbide material can have particles dispersed therein, for example, ZrSi₂ particles. In other embodiments, the ceramic material is a glass material, e.g., a silica glass or a silicate glass, silicon carbide or silicon carbonitride.

In the methods described above, either the final ceramic material or a precursor thereof can be provided onto the exposed surface of the silicon oxynitride layer. In certain embodiments, it is a precursor of the ultimately-desired ceramic material that is provided on the exposed surface of the silicon oxynitride layer. For example, in certain embodiments, a siloxane polymer (e.g., polyhydromethylsiloxane) is provided on the exposed surface of the silicon oxynitride layer; the siloxane polymer can be converted to silicon oxide or silicon oxycarbide by heat or application of other energy. In other embodiments, an organically modified silicate or a silica sol is provided on the exposed surface of the silicon oxynitride layer; these materials can be converted to amorphous siliceous materials by heat or application of other energy. In other embodiments, a carbon-containing polysilazane can be provided on the exposed surface of the silicon oxynitride layer; this material can be converted to silicon carbonitride by heat or application of other energy.

The ceramic materials in the methods described above can be formed with a variety of thicknesses. For example, in certain embodiments, the ceramic material is in the range of about 1 μm to about 5000 μm (e.g., about 100 to 1000 μm) in thickness. Of course, in other embodiments the ceramic material is thicker than about 1000 μm; in such embodiments, the silicon oxynitride can help to bond a ceramic body to a substrate.

In recent years, there has been an increasing interest in developing polymer derived ceramic (PDC) composite coatings on different metallic substrates as thermal or environmental barrier coatings (EBC). Such coatings are described, for example, in Günthner, M.; Schutz, A.; Glatzel, U.; Wang, K.; Bordia, R. K.; Greiβl, O.; Krenkel, W.; Motz, G., High performance environmental barrier coatings, Part I: Passive filler loaded SiCN system for steel. J. Eur. Ceram. Soc. 2011, 31, (15), 3003-3010; and Wang, K.; Günthner, M.; Motz, G.; Bordia, R. K., High performance environmental barrier coatings, Part II: Active filler loaded SiOC system for superalloys. J. Eur. Ceram. Soc. 2011, 31, (15), 3011-3020, each of which is hereby incorporated herein by reference in its entirety for all purposes. However, one common problem with all these coatings is the presence of residual porosity, which leads to catastrophic failures of the metal-ceramic interface due to the formation and growth of a thermally grown oxide (TGO) layer. As described in more detail below, the present inventors have determined that the methods described above can be used to provide thermal/environmental barrier coatings that are resistant to failure at the metal/ceramic interface. As the person of ordinary skill in the art will appreciate the silicon oxynitride bond coats described herein can be used with top coat materials described in the above-referenced publications.

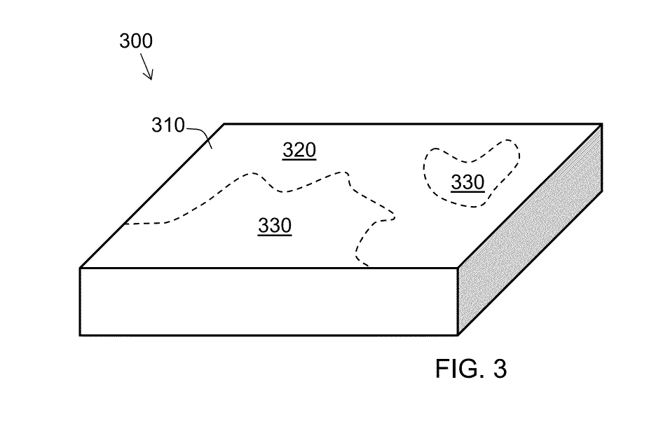

Another aspect of the disclosure is an article having a patterned surface in which different regions of the surface of the article have different surface energies. Such articles can be formed, for example, by exposing the regions to different amounts of energy (e.g., heat, radiation), thereby providing different surface energies to the regions, in the manner otherwise described herein. One embodiment is shown in schematic perspective view in FIG. 3. Article 300 includes a patterned surface 310. First region 320 has a first silicon oxynitride material at the patterned surface, the first silicon oxynitride material having a surface energy. Second region 330 has a second silicon oxynitride material at the patterned surface, the second silicon oxynitride material having a surface energy substantially lower than the surface energy of the first silicon oxynitride material. The first silicon oxynitride material and the second silicon oxynitride material are desirably substantially free of organic components. Articles with such patterned surface energies can be useful, for example, as substrates for the fabrication of other articles, e.g., with patterned polymeric layers or other patterned chemistries or functionalities formed thereon. Such articles can also be useful in fluid-handling and biological applications, e.g., to provide isolation of cells and microorganisms.

It can be especially desirable for there to be a substantial amount of surface energy contrast between the first region and the second region. For example, in certain embodiments, the surface energy of the second silicon oxynitride material is at least about 30 mN/m less than the surface energy of the first silicon oxynitride material. In various embodiments, the surface energy of the second silicon oxynitride material is at least about 32 mN/m less, at least about 35 mN/m less, or about 38 mN/m less than the surface energy of the first silicon oxynitride material. In certain embodiments, the surface energy of the second silicon oxynitride material is in the range of about 30 mN/m to about 40 mN/m less, about 32 mN/m to about 40 mN/m, or at least about 35 mN/m to about 40 mN/m less than the surface energy of the first silicon oxynitride material.

In certain embodiments, the second region is substantially contiguous with the first region on the patterned surface. For example, the second region is desirably within about 500 μm, within about 200 μm, or within about 100 μm of the first region. Such sharp transitions between regions of substantially different surface energy can be especially desirable when using the different regions to pattern liquids, e.g., liquid solutions of polymers to be applied onto the first regions. In certain embodiments, a first region is substantially surrounded by a second region, as shown in FIG. 3. In such embodiments, the lower surface energy of the second region can confine a liquid as a droplet disposed on the higher surface energy first region.

As described in more detail otherwise herein, exposure of substantially perhydrogenated polysilazanes to different amounts of energy can result in substantially different surface energies. In certain embodiments, the first silicon oxynitride material has a substantially lower concentration of Si—H bonds at the patterned surface than does the second silicon oxynitride material. As described in more detail below with respect to the experimental data, exposing a perhydrogenated silazane to relatively more energy provides a relatively higher surface energy due to removal of Si—H bonds from the surface thereof.

The first silicon oxynitride material can have, for example, a surface energy in the range of about 30 mN/m to about 65 mN/m. In certain embodiments, the first silicon oxynitride material has a surface energy in the range of about 30 mN/m to about 80 mN/m, or about 40 mN/m to about 80 mN/m, or about 50 mN/m to about 80 mN/m, or about 52 mN/m to about 80 mN/m, or about 55 mN/m to about 80 mN/m, or about 57 mN/m to about 80 mN/m, or about 30 mN/m to about 75 mN/m, or about 40 mN/m to about 75 mN/m, or about 50 mN/m to about 75 mN/m, or about 52 mN/m to about 75 mN/m, or about 55 mN/m to about 75 mN/m, or about 57 mN/m to about 75 mN/m, or about 30 mN/m to about 70 mN/m, or about 40 mN/m to about 70 mN/m, or about 50 mN/m to about 70 mN/m, or about 52 mN/m to about 70 mN/m, or about 55 mN/m to about 70 mN/m, or about 57 mN/m to about 70 mN/m, or about 40 mN/m to about 65 mN/m, or about 50 mN/m to about 65 mN/m, or about 52 mN/m to about 65 mN/m, or about 55 mN/m to about 65 mN/m, or about 57 mN/m to about 65 mN/m, or about 30 mN/m to about 60 mN/m, or about 40 mN/m to about 60 mN/m, or about 50 mN/m to about 60 mN/m, or about 52 mN/m to about 60 mN/m, or about 55 mN/m to about 60 mN/m, or about 57 mN/m to about 60 mN/m. The first silicon oxynitride material can be, for example, substantially hydrophilic at the patterned surface.

Whatever the surface energy of the first silicon oxynitride material, the second silicon oxynitride material has a substantially lower surface energy. For example, in one embodiment, the second silicon oxynitride material has a surface energy of no more than about 25 mN/m. In certain embodiments, the second silicon oxynitride material has a surface energy in the range of about 10 mN/m to about 25 mN/m, or about 10 mN/m to about 20 mN/m, or about 10 mN/m to about 15 mN/m, or about 15 mN/m to about 25 mN/m, or about 15 mN/m to about 20 mN/m, or about 20 mN/m to about 25 mN/m. The second silicon oxynitride material can be, for example, substantially hydrophobic at the patterned surface.

Another aspect of the disclosure is a method for making the article having the patterned surface as described above. In one embodiment, the method includes disposing a substantially perhydrogenated polysilazane on a surface of the article. The substantially perhydrogenated polysilazane is exposed to two different energies to form the two regions. In the first region, the substantially perhydrogenated polysilazane is exposed to energy sufficient to form the first silicon oxynitride film. In the second region, the substantially perhydrogenated polysilazane is exposed to energy sufficient to form the second silicon oxynitride film. As the surface energy is lower in the second region than in the first, the second region is exposed to substantially less energy than the first region. For example, in certain embodiments, in the first region, the substantially perhydrogenated polysilazane is heat-treated at a temperature of at least about 325° C. to form the first silicon oxynitride material; and in the second region, the substantially perhydrogenated polysilazane is heat treated at a temperature of no greater than about 300° C. to form the second silicon oxynitride material. In certain such embodiments, the substantially perhydrogenated polysilazane in the first region is heat-treated at a temperature of at least about 400° C., or at least about 500° C., or in the range of about 325° C. to about 1200° C., or in the range of about 400° C. to about 1200° C., or in the range of about 500° C. to about 1200° C., or in the range of about 325° C. to about 1000° C., or in the range of about 400° C. to about 1000° C., or in the range of about 500° C. to about 1000° C., or in the range of about 325° C. to about 800° C., or in the range of about 400° C. to about 800° C., or in the range of about 500° C. to about 800° C. In certain such embodiments, the substantially perhydrogenated polysilazane in the second region is heat treated at a temperature in the range of about 100° C. to about 300° C., or in the range of about 150° C. to about 300° C., or about 200° C. to about 300° C. The heating regiments may be performed for the times and under the conditions as described above. Of course, in other embodiments, different heating regimens can be used. In any event, the person of ordinary skill in the art can determine the necessary heating conditions to provide the desired surface energies to the first and second silicon oxynitride materials.

In other embodiments, types of energy other than heat (such as those described above) can be used to convert the substantially perhydrogenated polysilazane to the first silicon oxynitride material and the second silicon oxynitride material. The person of ordinary skill in the art will determine the necessary exposure conditions to provide the desired surface energies to the first and second silicon oxynitride materials.

The person of ordinary skill in the art can use conventional methodologies to provide the pattern of the first and second regions on the surface. For example, laser heating can be used to provide finely controlled heating at two different energy levels in the two regions. Electron beam lithography and photolithography can also be used to provide different energy exposures in the different regions.

The article can take many forms, for example, the form of a substrate bearing the silicon oxynitride materials of the first and second regions. The article can be formed from a variety of materials, e.g., metals (optionally with a metal oxide at the surface as otherwise described herein), ceramic materials such as glasses, silicon oxides, semiconductors such as silicon, among many others.

As the person of ordinary skill in the art will appreciate, the exposure of the various regions to energy (heat or otherwise) can be performed sequentially. It can particularly be useful to expose the first region to energy in two separate steps, one performed at the conditions under which the second region is exposed to energy, and another to provide the desired surface energy to the silicon oxynitride material of the first region. For example, the substantially perhydrogenated polysilazane can be disposed on the surface of the article, then the entire surface of the article (or, at least, both the first and second regions) can be exposed to energy sufficient to convert the substantially perhydrogenated polysilazane to the second silicon oxynitride material (i.e., having a relatively low surface energy) throughout both the first and second regions. The first region can then be exposed to additional energy (through masking or targeted radiation or otherwise targeted application of energy) in order to convert the second silicon oxynitride material to the first silicon oxynitride material (i.e., having a relatively high surface energy) in the first region, leaving the second region with a low surface energy. As the person of ordinary skill in the art will appreciate, conventional microelectronic processing techniques can be adapted for use into making patterned surfaces as described herein. For example, one particular approach to make pattered surfaces is to mask different regions and expose unmasked regions to either heat or UV radiation.

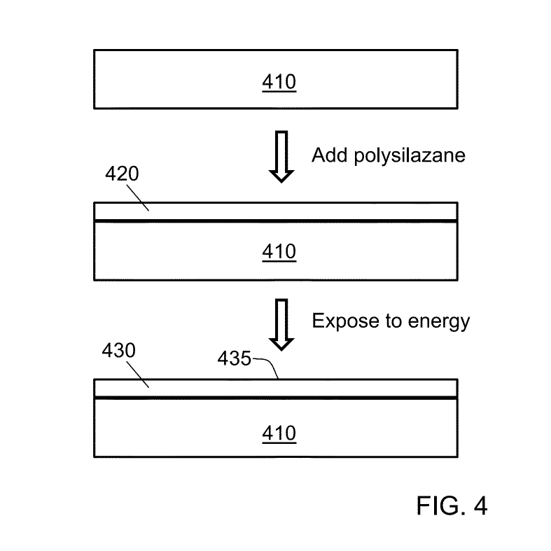

Another aspect of the disclosure is a method for forming an article having a silicon oxynitride material at the surface thereof, the silicon oxynitride material having a surface energy of no more than 30 mN/m. The method includes forming a layer of substantially perhydrogenated polysilazane on the article; exposing the layer of substantially perhydrogenated polysilazane to energy sufficient to form a silicon oxynitride layer having an exposed surface having a surface energy no more than about 30 mN/m; and refraining from exposing the silicon oxynitride layer having the exposed surface having the surface energy no more than about 30 mN/m to energy sufficient to increase the surface energy of the exposed surface to a value above about 30 mN/m. An example of such a method is shown in schematic view in FIG. 4. A layer 420 of substantially perhydrogenated polysilazane is formed on article 410. Layer 420 is exposed to energy, e.g., heat energy or radiation as described above, sufficient to form a silicon oxynitride layer 430 having an exposed surface 435 having a surface energy no more than about 30 mN/m. Critically, the method includes refraining from exposing the article to energy sufficient to increase the surface energy of the exposed surface to a value above about 30 mN/m. Thus, the surface energy of the surface of the article remains low. The surface of the article can thus be hydrophobic. Articles with low surface energies have a number of useful properties, including self-cleaning, anti-bacterial, anti-microbial and anti-fouling. The low surface energy articles described herein can be advantaged over other low surface energy articles. Low surface energy articles as described herein can be made without the need for micro- or nanostructuring a material, and can be more robust (e.g., mechanically and chemically) as a result of the ceramic-like nature of the silicon oxynitride materials.

In certain embodiments, layer of substantially perhydrogenated polysilazane is exposed to energy sufficient to form a silicon oxynitride layer having a surface energy of no more than about 25 mN/m. In certain embodiments, the second silicon oxynitride material has a surface energy in the range of about 10 mN/m to about 30 mN/m, or about 10 mN/m to about 25 mN/m, or about 10 mN/m to about 20 mN/m, or about 10 mN/m to about 15 mN/m, or about 15 mN/m to about 30 mN/m, or about 15 mN/m to about 25 mN/m, or about 15 mN/m to about 20 mN/m, or about 20 mN/m to about 30 mN/m, or about 20 mN/m to about 25 mN/m.

In certain embodiments, the method includes refraining from exposing the silicon oxynitride layer to energy sufficient to increase the surface energy of the exposed surface to a value above about 25 mN/m, about 20 mN/m, or about 15 mN/m. That is, the method includes preventing the silicon oxide layer from being exposed to energy sufficient to increase the surface energy of the exposed surface to a value above about 25 mN/m, about 20 mN/m, or about 15 mN/m. As the person of ordinary skill in the art would appreciate from the disclosure herein, exposure of a low-surface energy silicon oxynitride material to more energy would tend to push it through the surface energy transition and convert it to a higher surface energy material. By refraining from exposing the silicon oxynitride layer to such high energy, the person of ordinary skill in the art can retain a desirable low surface energy, and, for example, a substantially hydrophobic surface. Accordingly, the person of ordinary skill in the art will avoid higher-energy processes (e.g., involving strong UV radiation or high temperatures) in further processing of the article.

The exposure to energy can be performed in a variety of manners, for example, as described above with respect to the second silicon oxynitride material of the patterned article embodiments. In certain embodiments, the exposure of the layer of substantially perhydrogenated polysilazane to energy comprises heating at a temperature of no greater than about 300° C. In certain such embodiments, the substantially perhydrogenated polysilazane in the second region is heat treated at a temperature in the range of about 100° C. to about 300° C., or in the range of about 150° C. to about 300° C., or about 200° C. to about 300° C. The heating regiments may be performed for the times and under the conditions as described above. Of course, in other embodiments, different heating regimens can be used. In other embodiments, the exposure of the layer of substantially perhydrogenated silazane to energy comprises exposure to radiation, such as ultraviolet radiation. As described above, in certain embodiments, the exposure to energy of the layer of substantially perhydrogenated polysilazane is performed in an oxygen-containing atmosphere. In all cases, the person of ordinary skill in the art can determine the necessary conditions to provide the desired surface energy to the silicon oxynitride layer.

The substantially perhydrogenated silazanes described above can be used in practicing this aspect of the disclosure. For example, in one embodiment, the substantially perhydrogenated polysilazane is perhydrosilazane. The substantially perhydrogenated silazane can be formed as described above, for example, at a thickness in the range of about 10 nm to about 10 μm.

Another aspect of the disclosure is an article having a silicon oxynitride material at the surface thereof, the silicon oxynitride material having a surface energy of no more than 30 mN/m. The article can be made, for example, as described above, and can have surface energy values as described above. Notably, the article is not merely in the process of being fabricated, with the silicon oxynitride material being exposed to further energy to convert it to a substantially higher surface energy. The silicon oxynitride material can thus be substantially hydrophobic, which can be desirable in a variety of applications as described above.

Various aspects of the disclosure are further presented with respect to the description of the experiments, the data presented and the analysis thereof below.

### Experimental Description, Data and Analysis

Film Preparation:

Metal sheet (nickel-based superalloy Inconel 617) was cut into coupons of 30 mm×10 mm×1.2 mm (L×W×H) in size, polished to 1200 grit finish and cleaned using an ultrasonication bath prior to processing. For the silicon oxynitride (SiON) ceramic films, perhydropolysilazane PHPS NN 120-20 (a solution of 20 wt. % PHPS in dibutyl ether, Clariant Advanced Materials GmbH, Sulzbach, Germany) was used as the polymer precursor. For the double-layer environmental barrier coating systems, a SiON film served as the bond coat, while the top coat layer was a composite of filler particles and a polymer-derived SiOC ceramic matrix. The top coat was made from a precursor slurry of submicron ZrSi₂ particles (Accumet Materials Co., Ossining, N.Y., USA) and polyhydromethylsiloxane (PHMS) polymer (HMS-992, Gelest Inc., Morrisville, Pa., USA). To prepare the top coat slurry, 30 vol. % of ZrSi₂ powder was mixed with 70 vol. % of PHMS and half of the required n-octane (98+%, Alfa Aesar, Ward Hill, Mass., USA) solvent. The slurry was ball-milled (zirconia media) for 4 hours in order to mix all the reactants well and remove agglomerates. 0.05 wt % of Ru₃(CO)₁₂ (Alfa Aesar) catalyst (with respect to PHMS) was dissolved in the other half of the required n-octane, and the resulting solution was added to the slurry, which was ball-milled for another 30 minutes prior to dip coating. The volume ratio of (filler+PHMS) to n-octane was 3:5.

Coating layers (of both the PHPS and the top coat precursor slurry) were prepared by dip-coating, using a mechanical testing frame, Instron 4505 (Illinois Tool Works Inc., Norwood, Mass., USA), in sequence. Moderate withdrawal speed was used: 500 mm Reproducible processing of these coatings requires control over the viscosity of the slurry and the withdrawal speed.

Heat treatments (i.e., for both the conversion of PHPS to SiON and the conversion of the precursor to the top coat) were performed in a tube furnace with flowing air (flux rate: ˜3 L h⁻¹) environment. Heat treatment of the PHPS was performed at a variety of temperatures between room temperature (RT) and 800° C. (RT, 200° C., 400° C., 600° C. and 800° C.; heating rate: 2° C./min, holding time: 2 h). For the systems including a top coat, the PHPS was heated at 800° C. as described above, and conversion of the precursor layer to the top coat was performed in two steps. First the PHMS was cross-linked at 150° C. (heating rate: 2° C./min, holding time: 2 h) in the presence of humid air (˜40 mL of water placed in the tube). After cross-linking, the precursor was heated at 800° C. (heating rate: 2° C./min, holding time: 2 h) to form the top coat.

Surface Energy Characterization: Contact angle measurements were carried out on an optical goniometer instrument (VCA Optima, AST Products, Inc., Billerica, Mass., USA). Shape of drops with a pre-determined volume (0.5-1 μL) was recorded by a CCD camera and then contact angles were measured using the analysis software (VCA Optima Series). Surface energy was composed of additive polar and dispersive portions,

γᵢ=γᵢ^{P}+γᵢ^{D}

where i denotes a specific phase (solid S or liquid L) and the superscripts P and D denote the polar and dispersive components. These two components are responsible for the non-London interactions (polar forces, such as hydrogen bonding) and the London dispersion interactions (induced dipole-dipole forces, such as Van der Waals force) between the two phases, respectively. A Kaelble plot was used to derive these two components and the master equation took a linear regression form, shown as follows,

$$\frac{{γ}_{L} ( 1 + cos θ )}{2 \sqrt{{γ}_{L}^{P}}} = \sqrt{{γ}_{S}^{D}} ( \sqrt{\frac{{γ}_{L}^{D}}{{γ}_{L}^{P}}} ) + \sqrt{{γ}_{S}^{P}}$$

in which θ is the contact angle. Mapping this to the typical linear equation y=ax+b, with

$$x = \sqrt{\frac{{γ}_{L}^{D}}{{γ}_{L}^{P}}}$$

$$and$$

$$y = \frac{{γ}_{L} ( 1 + cos θ )}{2 \sqrt{{γ}_{L}^{P}}}$$

the slope ‘a’ and intercept ‘b’ correspond respectively to the square roots of dispersive and polar surface energy components of the solid phase. To determine the ‘a’ and ‘b’ values, the contact angle θ with different known liquids (having known surface energies) was measured. Three different liquids were used, having the listed surface energies (both polar and dispersive components) in units of mN/m: deionized water (γ^{P}: 50.3, γ^{D}: 21.5), ethylene glycol (γ^{P}: 15.2, γ^{D}: 32.8) and formamide (γ^{P}: 23.5, γ^{D}: 34.4). Using the contact angle data and the γ^{P} and γ^{D} values for the three liquids, the γ^{P} and γ^{D} values for a particular surface can be determined. Contact angle data were collected on PHPS films annealed at RT, 200, 250, 300, 350, 400, 600 and 800° C. A larger number of films were investigated between 200° C. and 400° C. because this was the temperature range of significant changes in film's surface chemistry. Further details regarding surface energy calculations can be found in Fowkes, F. M., Determination of interfacial tensions, contact angles, and dispersion forces in surfaces by assuming additivity of intermolecular interactions in surfaces. J. Phys. Chem-US. 1962, 66, (2), 382; Kaelble, D. H., Dispersion-polar surface tension properties of organic solids. J. Adhesion 1970, 2, 66-81; and Matsunaga, T.; Ikeda, Y., Dispersive component of surface free energy of hydrophilic polymers. J. Colloid Interf. Sci. 1981, 84, (1), 8-13, each of which is hereby incorporated herein by reference in its entirety.

Chemical and Microscopic Analysis:

Chemical analysis on the PHPS films was performed using Fourier transform infrared spectroscopy (FTIR) (powder) and Raman spectroscopy (785 nm laser, Renishaw inVia Raman Microscope, Renishaw Inc., Hoffman Estates, Ill., USA). Pellet samples for FTIR were made from powders (particle size: <35 μm) derived from PHPS annealed in air for 2 hours at temperatures between RT and 800° C. at 200° C. interval. A Perkin Elmer 1720 (wavenumber 4000-400 cm⁻¹ and step size 0.5 cm⁻¹) series FTIR spectrophotometer was used in transmission mode. Finally, microstructures of the films and coating systems were examined using scanning electron microscopy (SEM) (JSM-7000F, JEOL-USA, Inc., Peabody, Mass., USA).

### Analysis of Experimental Data

While not intending to be bound by theory, the inventors provide the following discussion of the data generated as described above:

Surface Energy of SiON Films from Contact Angle Measurements

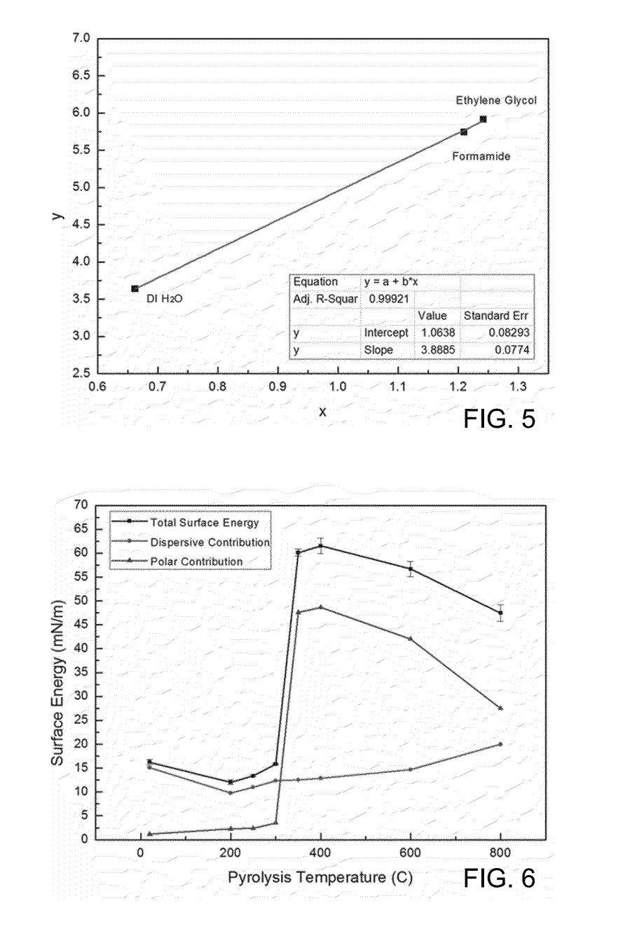

In an oxidizing environment, the heat treatment of PHPS films is essentially an oxygen-enriching process of crosslinked (SiH₂NH)ₙ network that involves both compositional and microstructural evolutions. This leads to a continuous change in the bonding states of the atoms on the outermost layer of the film. This change in surface chemistry leads to a change in surface energy, which can be quantitatively characterized by contact angle measurement as described above. FIG. 5 is the Kaelble plot of the film synthesized at room temperature. Each data point represents the average contact angle from ten measurements using that liquid. The results for the three tested liquids follow a straight line as expected in the Kaelble plot. The slope of the fitted straight line is determined to be 3.89 mN^{1/2}/m^{1/2} and its intercept is 1.06 mN^{1/2}/m^{1/2}. Hence, for the room temperature-synthesized film, the dispersive component of the surface energy is 15.12 mN/m, while its polar component is 1.13 mN/m. The surface energies for films heat-treated at other temperatures were calculated in the same manner. Both the polar and the dispersive components, and the total surface energy of PHPS films (in air) are plotted as a function of heat treatment temperature in FIG. 6.

Surprisingly, the plot of FIG. 6 exhibits a substantial increase in surface energy at an onset temperature of ˜300° C. For films heat-treated between room temperature and 300° C., the total surface energy is relatively low and varies between 12 and 16 mN/m. However, after the transition, between 300° C. and 400° C., the measured surface energy reaches its maximum—62 mN/m at 400° C. before decreasing to 48 mN/m at the highest heat treatment temperature of 800° C. Analysis of the dispersive and polar components of the surface energy provides a reason for the PHPS surface change from low surface energy to high surface energy with increasing heat treatment temperature. The dispersive component for the surface energy of PHPS films does not vary significantly as temperature increases, with a range from 6.15 to 19.96 mN/m. Since the London dispersion forces are induced between adjacent molecules, they are secondary and weak, but increase as the distance is reduced, as is the case in in densification processes. The highest dispersion component is found in the sample treated at 800° C., indicating that the ceramic phase product at this temperature is densified the most. On the other hand, the polar component increases significantly from 1.13 mN/m for room temperature prepared films to 48.66 mN/m for those annealed at 400° C.—an increase of about 40 times. As a result, the surface converts from low to high polar characteristic in a relatively narrow temperature window of 100° C. (between 300 and 400° C.).

### Chemical Analysis of the Pyrolysis of PHPS

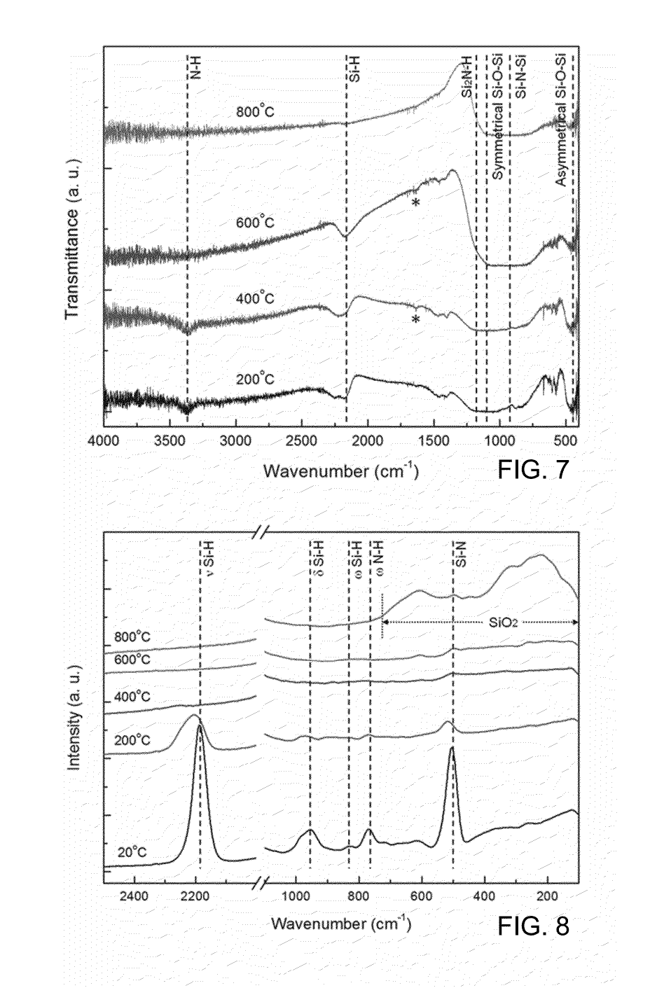

FTIR and Raman spectroscopy was used to investigate the changes in the chemical state of the film during annealing in order to understand the mechanism of the surface energy transition. The FTIR and Raman spectra are presented in FIGS. 7 and 8, respectively, and the specific assignments of absorption bands and peaks are compiled in Table 1. In FIG. 7, the (*) marks the —OH group absorption due to adsorbed water. In FIG. 8, a broad band of Si—N and Si—O appears on the lower wavenumber end at 400° C. and above. Beside the well-defined assignments, a noticeable common feature in the two spectra is that a wide band composed of multiple Si—O—Si bonds is observed at the lower wavenumber end for films annealed at 400° C. and above. In the Raman spectra, this wide band has the characteristic Raman shifts analogous to that of pure amorphous silica.

TABLE 1
FTIR absorption band and Raman shift peak
assignments of the products of PHPS.

| Wavenumber [cm⁻¹] | Assignment | Source |
|---|---|---|
| 3380 | ν (N—H) | FTIR |
| 2183 | ν (Si—H) | Raman |
| 2160 | ν (Si—H) | FTIR |
| 1180 | ρ (Si₂N—H) | FTIR |
| 1080 (1250-1000) | ν Si—O—Si, symmetrical | FTIR |
| 955 | δ (Si—H) | Raman |
| 922 | ν Si—N—Si | FTIR |
| 829 | ω (Si—H) | Raman |
| 768 | ω (N—H) | Raman |
| 505 | Si—N | Raman |
| 700-100 | Si—O—Si, amorphous | Raman |
| 475 | ν Si—O—Si, asymmetrical | FTIR |

Note:
ν—stretching; ρ—rocking; δ—deformation; ω—wagging.

The FTIR spectra yield insight into the conversion process of the PHPS polymer. For low temperature annealing, the film showed characteristics of ligands including elements like hydrogen. As annealing temperature increases, both N—H and Si—H bands decreased in intensity due to crosslinking and conversion to ceramic phase. N—H band completely disappeared after 400° C., while intensity of the Si—H band strongly decreased after 600° C., i.e., the hydrogen atoms bonded to nitrogen were most reactive and were released in small molecule forms during the early stage of annealing, followed by the Si—H group. After annealing at 800° C., there was no evidence of hydrogen in the final product, so it became a SiON ceramic. Similar trends are observed for the Si₂N—H group. Its absorption band at 1180 cm⁻¹ disappeared after 400° C. Up to 800° C., Si—O—Si and Si—N—Si bands were observed and prominent. Particularly, Si—N—Si was embedded in the broad Si—O—Si band, and a similar situation could also be found in the Raman spectra too. The Si—N—Si bonding is in PHPS' molecular structure, while Si—O—Si is due to the substitution of nitrogen atoms with oxygen due to annealing in air. In addition, the intensity of these absorption bands grew substantially with increasing temperature, showing the progress of pyrolysis. Similar results have been reported on other types of polysilazane polymers.

The Raman spectra agree well with the results from the FTIR spectra, except that Raman scattering seems to be more sensitive to different vibrational modes of Si—H bonds. ν (Si—H), δ (Si—H) and ω (N—H) peaks have strong intensities for the PHPS film deposited at room temperature, they diminish significantly when crosslinking takes place at 200° C., and eventually vanish at 400° C. when the film converts to a ceramic-like inorganic material. At about 505 cm⁻¹, the Si—N bond is the backbone of PHPS molecules and has a strong signal for samples annealed at low temperatures. This band is significantly reduced as temperature increases, but is still present up to 800° C. The reason for its decrease in intensity is that nitrogen was gradually replaced by oxygen, therefore, as the annealing temperature increases, there are fewer Si—N bonds. As shown in FIG. 8, distinguishable amorphous silica peaks start to show up in the low wavenumber region (roughly 700-100 cm⁻¹) for samples annealed at 400° C. and grow as the temperature increases up to 800° C. Si—O—Si asymmetrical stretching in this range (at 475 cm⁻¹) was also observed in FTIR spectra.

Combined FTIR and Raman spectroscopic analysis demonstrated that a PHPS film could be fully converted to an inorganic ceramic material at temperature as low as 400° C., as evidenced by the almost complete disappearance of hydrogen. Oxygen is found in the FTIR spectra of PHPS films heat-treated at low temperatures, e.g., 200° C. This may be attributed to three possible oxygen sources: the native oxygen impurity in the PHPS molecules, the incorporated oxygen due to partial crosslinking at room temperature, and the —OH group due to exposure in air. For heat treatment at 800° C. in air, the final product exhibits a mixture of Si—O (majority) and Si—N bonds, but the four bonded atoms of the Si tetrahedron can be any combination of O and N. Therefore, it is a silicon oxynitride amorphous film.

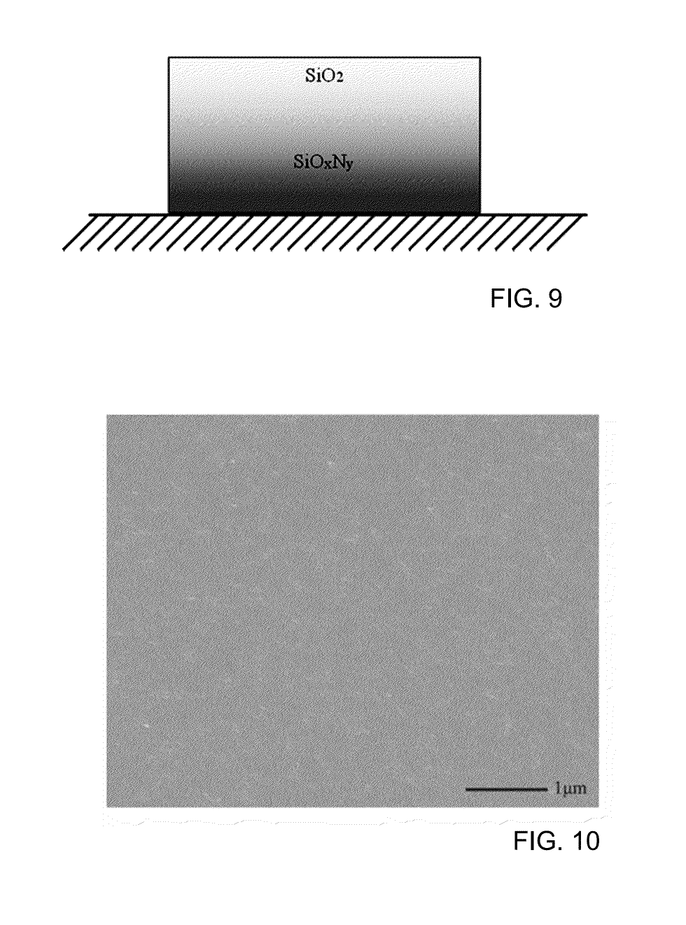

A detailed XPS investigation on these films revealed that there was only negligible intensity of Si—N bonds at or near the top surface (within about 2 nm) of the SiON films annealed at 600° C. and above. Particularly, the empirical formula of annealed SiON films (disregarding H content) at the surface evolves from SiO_{0.616}N_{0.284}Hₓ (at RT) to SiO_{1.881}N_{0.003} (at 800° C.)—a significant decrease in the N content. A previously-reported glow discharge optical emission microscopy (GDOES) measurement on a similar PHPS film pyrolyzed at 800° C. demonstrated that this top SiO₂ layer can be roughly 15% of the total film thickness. In contrast, both the FTIR and Raman studies described above confirmed the presence of significant Si—N bond content in PHPS films heat treated at temperatures as high as 800° C. Without intending to be bound by theory, the inventors believe this is due to the much higher probe depth of these spectroscopic techniques, and that the Si—N signal in the Raman spectra is from the interior of the film. Thus, the inventors believe that the silicon oxynitride films heat treated at high temperature exhibit an oxygen gradient, or equivalently a nitrogen gradient, in the thickness direction, which is schematically depicted in FIG. 9. The inventors also (again, without intending to be bound by theory) propose a possible mechanism for the formation of chemical inhomogeneity in the fully converted films: as the film is converted to a ceramic, the dense top surface of the amorphous SiO₂ network impedes further diffusion of oxygen atoms into the bulk of the film, leading to a compositional gradient after heat treatment.

The observed changes in the chemical state of the PHPS suggest a likely explanation for the significant surface energy transition described above with respect to FIG. 6 (again, without intending to be bound by theory). At low temperatures (<300° C.), the top surface of films is mainly terminated by covalently bonded hydrogen. The silicon atoms that bond to those surface hydrogen atoms are also saturated by their adjacent atoms, such as N, Si, H and certain amount of O. There are no spare electron pairs to make the surface easily polarized owing to the formation of σ bonds in sp³ hybrid silicon, therefore, the film surface exhibits the characteristic of low polar contribution. In fact, there are two possible contributors to the polar component at low temperatures: N—H bonds and foreign —OH groups. Unlike saturated silicon, nitrogen atoms possess lone electron pairs so that N—H terminated part of the surface should have higher energy than Si—H terminated parts. However, both Raman spectra and the XPS result (SiO_{0.616}N_{0.284}Hₓ) demonstrate that nitrogen is largely deficient and the amount of Si—H bonds is much higher than N—H bonds even at room temperature; thus N—H bonds can only have very limited effect on the polar contribution and consequently on the overall surface energy. Likewise, the amount of —OH groups attached to silicon due to oxygen contamination is expected to be very small but reactive with light weight species, such as hydrogen, which has a partial negative charge in the Si—H bonds due to its higher electronegativity (hydridic hydrogen), and is positively charged in the N—H bonds (acidic hydrogen). Thus, PHPS is highly reactive with hydroxyl groups due to a large amount of Si—H and N—H bonds. Having both hydridic and acidic hydrogen atoms, the crosslinking of the PHPS via H₂ and H₂O elimination is easily possible at relatively low temperatures. As conversion continues to progress at increasing temperatures, more and more hydrogen and nitrogen are released in forms like H₂, H₂O and NH₃, and oxygen gets incorporated into the film. For films annealed at 400° C., silicon is mostly bonded to oxygen on the film surface, thus the surface is primarily terminated by covalently bonded oxygen. Then, there are two possible scenarios: if the oxygen atoms are fully bonded, e.g., Si—O—Si, the spare electron pair in oxygen is able to form hydrogen bond or attract other polar species; contrarily, if the terminating oxygen is not saturated by other atoms in the material, it is most likely to form —OH group on the surface. Both of these mechanisms lead to the transition of PHPS film surface from hydrophobic to hydrophilic with a high polar component in surface energy.

However, the polar component noticeably drops from the maximum 48.66 mN/m at 400° C. to 27.51 mN/m at 800° C.—a decrease of ˜43%. This could be correlated with different stages in the PHPS pyrolysis. Thermogravimetric (TG) analysis on PHPS reveals that the weight gain associated with its pyrolysis in air mainly lies between 150° C. and 400° C., during which significant chemical reactions, as discussed above, take place both in the body and on the surface of the evolving film. (This TG experiment is described in Günthner, M.; Wang, K.; Bordia, R. K.; Motz, G., Conversion behaviour and resulting mechanical properties of polysilazane-based coatings. J. Eur. Ceram. Soc. 2012, 32, (9), 1883-1892, which is hereby incorporated herein by reference in its entirety for all purposes.) The TG result explains the substantial increase in surface energy due to the formation of highly polar Si—OH bonds up to this point. Subsequently, beyond 400° C., the film gets into the densification stage so that Si—OH bonds are gradually removed and replaced by Si—O—Si bonds, resulting in a less and less polar surface. Upon further heating above 800° C., it can be speculated that the polar and dispersive components will continue to decrease and increase, respectively.

PHPS can be heat treated to form films with a dense microstructure. For example, a layer of PHPS was heat treated at 800° C. to form a silicon oxynitride film. FIG. 10 is a micrograph of the top surface of the silicon oxynitride film so formed, demonstrating that it is densified.

### Hydrophilic SiON Films as Bond Coat in a Multilayer Coating System

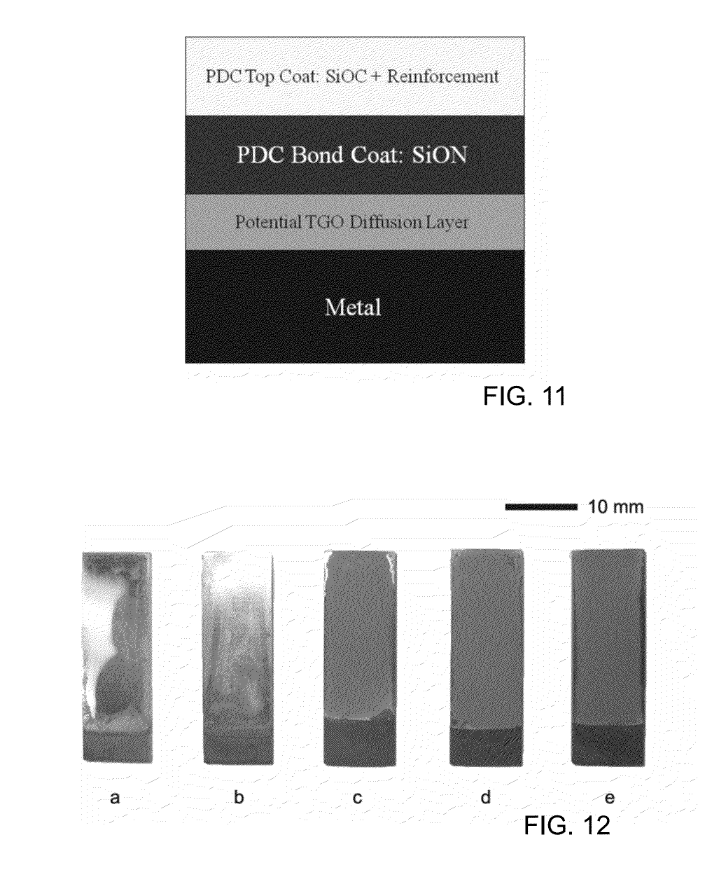

Multilayer coatings were fabricated as described above. A schematic cross-sectional view of an example of a multilayer coating system is provided as FIG. 11. In the experiments described herein, the “potential TGO diffusion layer” (i.e., a thermally grown oxide) is not present as a thick layer, but the very surface of the metal does present a thin oxide film (roughly an atomic layer thick) due to atmospheric oxidation. Details of the fabrication procedure are provided above; further details of filled top-coat materials are described in Günthner, M.; Schutz, A.; Glatzel, U.; Wang, K.; Bordia, R. K.; Greiβl, O.; Krenkel, W.; Motz, G., High performance environmental barrier coatings, Part I: Passive filler loaded SiCN system for steel. J. Eur. Ceram. Soc. 2011, 31, (15), 3003-3010 and Wang, K.; Günthner, M.; Motz, G.; Bordia, R. K., High performance environmental barrier coatings, Part II: Active filler loaded SiOC system for superalloys. J. Eur. Ceram. Soc. 2011, 31, (15), 3011-3020, each of which is hereby incorporated herein by reference in its entirety. FIG. 12 is a set of top-view photographs of ZrSi₂-filled SiOC composite coatings (heat treated at 800° C. in air) on SiON bond coat layers (with Inconel 617 substrates). Prior to applying the top coat, the SiON layers were heat treated at (a) RT; (b) 200° C.; (c) 400° C.; (d) 600° C.; and (e) 800° C. The top coats completely spalled off in samples (a) and (b), leaving the highly reflective, transparent, glassy SiON bond coat still well bonded to substrates. Samples c, d and e remain intact with their top coat layers well adhered. The bottom portion of each sample was bare alloy that suffered from heavy oxidation after 800° C. heat treatment. Accordingly due to the dramatic change in surface energy with PHPS heat treatment temperature as described above, only the double-layer coatings with PHPS bond coat annealed at 400° C. and higher had proper wetting at the interface for the PHMS composite coating and were able to survive the final heat treatment of 800° C. Note that 400° C. is the temperature when bond coat possesses the highest surface energy.

The delamination of top coat layer is likely to happen after PHMS crosslinking (150° C.) but before ceramic conversion (600-800° C.). Experimentally, it was observed that PHMS top coats that spalled off from RT- and 200° C.-treated PHPS bond coats remained in a single thin piece having a wavy contour. This implies that when the PHMS top coat is applied on the low-temperature annealed PHPS bond coat surface, the very poor wetting between the PHMS and the PHPS limits bonding due to the weak London dispersive contribution. Therefore, the top coat is more or less “free standing” during the final heat treatment. It crosslinks and shrinks at 150° C., and then spalls off completely before there is enough activation energy to form primary chemical bonds between the two layers. Accordingly, in such a multilayer system, a hydrophilic bond coat is desired to bond the top coat in the polymeric state.

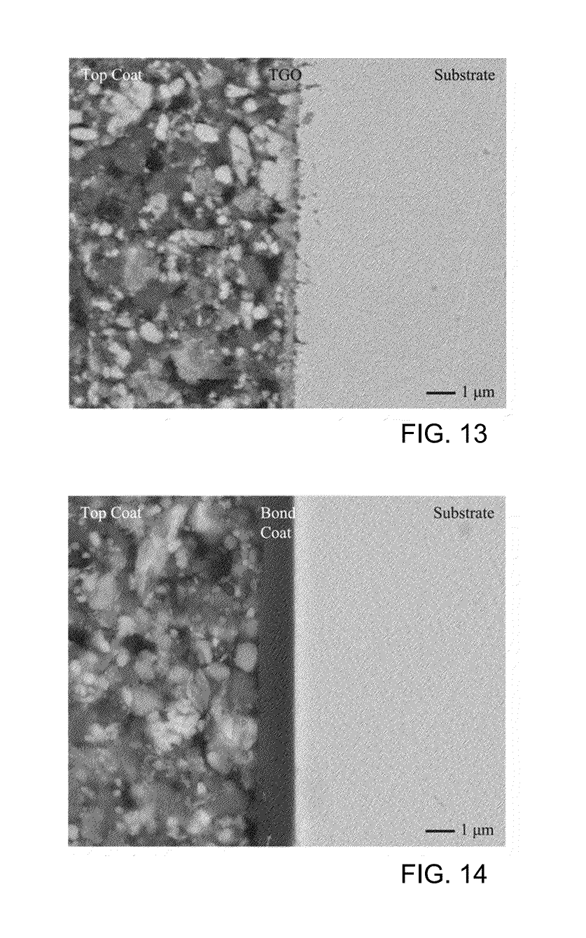

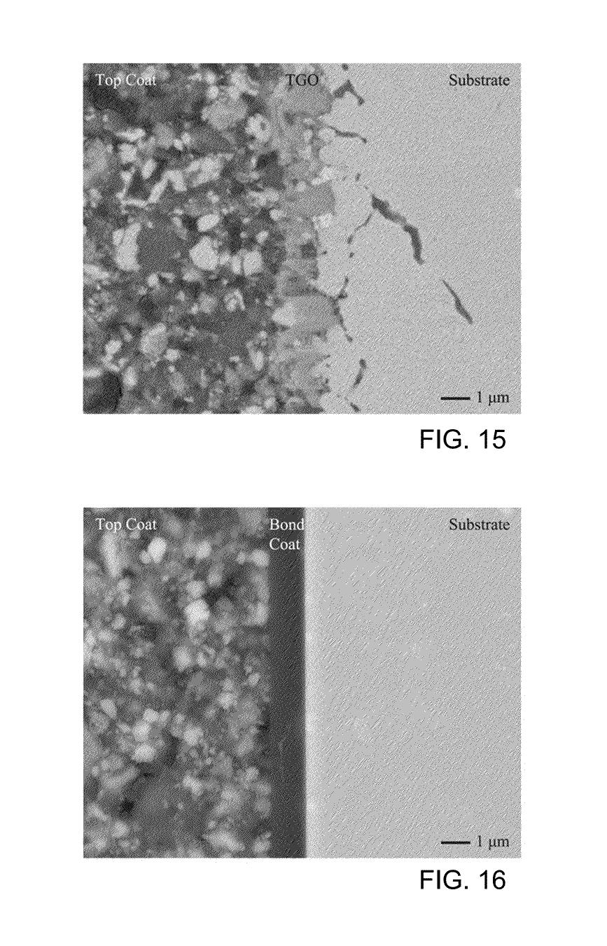

The effectiveness of the SiON/PHPS bond coat as an oxygen barrier was examined by long-term static oxidation tests (at 800° C. for 200 hours). FIGS. 13-16 are cross-sectional SEM images (backscattered) of two polymer-derived EBC systems, comparing a double-layer coating system (top coat/bond coat) with the single-layer (top coat only) counterpart before and after 200 hours of oxidation exposure. FIGS. 13 and 15 are of single-layer ZrSi₂-filled SiOC coatings on nickel-based superalloy Inconel 617 respectively at time zero and after 200-hour oxidation at 800° C. FIGS. 14 and 16 are of a double-layer ZrSi₂-filled SiOC top coat/SiON bond coat system, respectively at time zero and after 200-hour oxidation at 800° C. FIGS. 13 and 14 demonstrate that both types of coatings have good adhesion with the substrate after fabrication and initial heat treatment. In FIG. 13, the very thin layer (<0.5 μm) between the PHMS coating and the substrate is in fact a thermally-grown oxide (TGO) layer. This layer is believed to be formed by oxygen infiltration through the PHMS coating precursor to the metal/PHMS interface. At this point, the TGO layer plays a positive role in the coating system by providing direct and robust chemical bond between the coating and the substrate. On the other hand, in FIG. 14, no TGO layer can be observed on either side of the 1-1.5 μm thick SiON bond coat.

However, after 200 hour exposure, there is a distinct difference between the two coating systems as shown in FIGS. 15 and 16. For the PHMS coating in FIG. 15, the most important feature is the growth of TGO layer (from ˜0.4 μm to ˜1.6 μm) at the metal-ceramic interface and the propagation of internal cracks roughly 1 μm underneath the metal surface. Based on the microstructure at 200 hours, it can be extrapolated that eventual failure of the single-layer coating would result from the continuing propagation of these internal cracks, leading to the spallation of the coating layer. In fact, signs of spallation that were about to occur could already be found in parts of the coating sample at 200 hours. This phenomenon has been suggested to proceed via cohesive bonding of the TGO layer with the ceramic and ductile failure of the metal. FIG. 15 demonstrates that the TGO layer has a stronger bonding with the PHMS top coat. The growth of the TGO layer is mainly due to the significant interdiffusion of oxygen (from environment) and metallic atoms (from the substrate) towards the ceramic-metal interface, which is postulated to have led to the formation of internal cracks (voids). Thus, the interface fracture can be attributed to the nucleation, growth and coalescence of these voids. In such a constrained layered system with strong ceramic-metal bonds, high hydrostatic stress builds up near the interface due to its inherent limitations on slip. These stresses are relieved by the formation of voids. The continued growth of these voids under the high tensile hydrostatic stresses leads to the failure of the system by the formation of cracks in the metal adjacent to the ceramic-metal interface.

In contrast, the double-layer coating system (FIG. 16) after 200 hours of oxidation shows almost no change in its microstructure due to the long exposure. No damage can be observed in top coat, bond coat or the substrate. Furthermore, no reaction products are formed at the top coat/bond coat interface and the TGO layer (<0.15 μm, measured from SEM micrograph) at the bond coat/substrate interface was observed to be less than 1/10 of the thickness of the bond coat itself. Most importantly, the metallic substrate remains intact, which can lead to a substantially prolonged service life.

Thus, an amorphous silicon oxynitride ceramic film was fabricated by the heat treatment of an inorganic polymer, perhydropolysilazane (PHPS). Notably, its surface energy showed a significant transition from low surface energy (more hydrophobic) to higher surface energy (more hydrophilic) within a narrow annealing temperature window of ˜100° C. The total surface energy increased about 5 times, which was primarily due to an increase in the polar component of 20-40 times. Without intending to be bound by theory, the phenomenon was explained by studying the chemical evolution on the surface of the film as a function of heat treatment temperature. It was demonstrated that heat treatment in air could lead to films with compositional gradients in oxygen and nitrogen along the thickness direction. The dense and hydrophilic SiON ceramic was then used as the bond coat in a double-layer EBC system, which showed outstanding performance in long-term static oxidation tests at 800° C.

1. A method for forming a ceramic/substrate interface comprising a ceramic material disposed on a substrate, the method comprising:
forming a layer of substantially perhydrogenated polysilazane on a surface of a substrate;
exposing the layer of substantially perhydrogenated polysilazane to energy sufficient to form a silicon oxynitride layer having an exposed surface, the exposed surface of the silicon oxynitride layer having a surface energy of at least about 50 mN/m;
disposing a ceramic material or a precursor thereof on the exposed surface of the silicon oxynitride layer; and
exposing the layer of the ceramic material or the precursor thereof to sufficient energy to form the ceramic/substrate interface.

2. The method according to claim 1, wherein the exposed surface of the silicon oxynitride film has a surface energy of at least about 52 mN/m.

3. The method according to claim 1, wherein the exposed surface of the silicon oxynitride film has a surface energy in the range of about 50 mN/m to about 80 mN/m.

4. The method according to claim 1, wherein the exposing the layer of substantially perhydrogenated polysilazane to energy comprises heat treating the layer of substantially perhydrogenated polysilazane at a temperature in the range of about 325° C. to about 750° C. to form the silicon oxynitride layer.

5. The method according to claim 4, wherein the layer of substantially perhydrogenated polysilazane is heat treated at a temperature in the range of about 325° C. to about 700° C.

6. (canceled)

7. The method according to claim 4, wherein the layer of substantially perhydrogenated polysilazane is heat treated for a time in the range of about 1 minute to about 10 hours.

8. (canceled)

9. The method according to claim 4, wherein the exposed surface of the silicon oxynitride film has a surface energy in the range of about 50 mN/m to about 80 mN/m.

10. The method according to claim 1, wherein the substantially perhydrogenated polysilazane is perhydrosilazane.

11. The method according to claim 1, wherein the layer of substantially perhydrogenated polysilazane is in the range of about 10 nm to about 10 μm in thickness.

12. The method according to claim 1, wherein the heat treatment of the layer of substantially perhydrogenated polysilazane is performed in an oxygen-containing atmosphere.

13. The method according to claim 1, wherein substrate is a metal substrate, optionally with a surface layer of metal oxide.

14. The method according to claim 1, wherein the ceramic material or the precursor thereof has a thickness in the range of about 1 μm to about 1000 μm.

15. An article having a patterned surface, the article comprising at least
a first region having a first silicon oxynitride material at the patterned surface, the first silicon oxynitride material having a surface energy; and
a second region having a second silicon oxynitride material at the patterned surface, the second silicon oxynitride material having a surface energy substantially lower than the surface energy of the first silicon oxynitride material.

16. The article according to claim 15, wherein the surface energy of the second silicon oxynitride material is at least about 30 mN/m less than the surface energy of the first silicon oxynitride material.

17. The article according to claim 15, wherein the second region is substantially contiguous with the first region on the patterned surface.

18. The article according to claim 15, wherein the first silicon oxynitride material has a substantially lower concentration of Si—H bonds at the patterned surface than does the second silicon oxynitride material.

19. (canceled)

20. The article according to claim 15, wherein the first silicon oxynitride material has a surface energy in the range of about 30 mN/m to about 65 mN/m.

21. (canceled)

22. The article according to claim 15, wherein the second silicon oxynitride material has a surface energy in the range of about 10 to about 25 mN/m.

23-24. (canceled)

25. A method for making the article according to claim 15, the method comprising
disposing a substantially perhydrogenated polysilazane on a surface of the article;
in the first region, exposing the substantially perhydrogenated polysilazane to energy sufficient to form the first silicon oxynitride film;
in the second region, exposing the substantially perhydrogenated polysilazane to energy sufficient to form the second silicon oxynitride film, the second region being exposed to substantially less energy than the first region.

26. (canceled)

27. A method for forming an article having a silicon oxynitride material at the surface thereof, the silicon oxynitride material having a surface energy of no more than 30 mN/m, the method comprising:
forming a layer of substantially perhydrogenated polysilazane on the article;
exposing the layer of substantially perhydrogenated polysilazane to energy sufficient to form a silicon oxynitride layer having an exposed surface having a surface energy no more than about 30 mN/m; and
refraining from exposing the silicon oxynitride layer having the exposed surface having the surface energy no more than about 30 mN/m to energy sufficient to increase the surface energy of the exposed surface to a value above about 30 mN/m.

28. (canceled)

29. The method according to claim 27, wherein the layer of substantially perhydrogenated polysilazane is exposed to energy sufficient to form a silicon oxynitride layer having an exposed surface having a surface energy in the range of about 10 mN/m to about 25 mN/m.

30. (canceled)

31. The method according to claim 27, wherein the exposure of the layer of substantially perhydrogenated polysilazane to energy comprises heating at a temperature of no greater than about 300° C.

32. The method according to claim 27, wherein the exposure of the layer of substantially perhydrogenated polysilazane to energy comprises exposure to ultraviolet radiation.

33. The method according to claim 27, wherein the exposure to energy of the layer of substantially perhydrogenated polysilazane is performed in an oxygen-containing atmosphere.

34. The method according to claim 27, wherein the substantially perhydrogenated polysilazane is perhydrosilazane.

35. (canceled)
